(19) United States
(12) Patent Application Publication
(10) Pub. No.: US 2010/0055355 A1
(43) Pub. Date: Mar. 4, 2010

(54) Cellulose Acylate Film, Optical Compensation Film, Polarizing Plate, and Liquid-Crystal Display Device

(75) Inventor: Hidenori Hayashi, Minami-ashigara-shi (JP)

Correspondence Address: BUCHANAN, INGERSOLL & ROONEY PC, POST OFFICE BOX 1404, ALEXANDRIA, VA, 22313-1404, US

(73) Assignee: FUJIFILM Corporation, Minato-ku (JP)

(21) Appl. No.: 12/548,589

(22) Filed: Aug. 27, 2009

(30) Foreign Application Priority Data
Aug. 27, 2008 (JP) 2008-217568
Feb. 12, 2009 (JP) 2009-029381

(51) Int. Cl. G02F 1/13363; G02B 5/30; G02B 1/08; B32B 5/00; C09K 19/02

(52) U.S. Cl. 428/1.31; 359/500; 428/220; 349/117

(57) ABSTRACT

The invention relates to a cellulose acylate film whose thickness is from 10 μm to 40 μm, retardation in plane at a wavelength 590 nm, Re(590), satisfies 40 nm≦Re(590)≦70 nm, and retardation along the thickness direction at a wavelength 590 nm, Rth(590), satisfies 90 nm≦Rth(590)≦150 nm; and which comprises at least cellulose acetate propionate, cellulose acetate butyrate or cellulose acetate propionate butyrate, having a total degree of acyl substitution of from 2 to 2.35 and a degree of propionyl and/or butyryl substitution of from 0.6 to 1.1.

### CROSS-REFERENCE TO RELATED APPLICATIONS

This application claims benefit of priority under 35 U.S.C. 119 to Japanese Patent Application Nos. 2008-217568, filed on Aug. 27, 2008, and 2009-029381, filed on Feb. 12, 2009, which are expressly incorporated herein by reference in its entirety.

### BACKGROUND OF THE INVENTION

1. Technical Field

The present invention relates to a cellulose acylate film, an optical compensation film, a polarizing plate, and a liquid-crystal display device.

2. Background Art

Heretofore, cellulose acylate films are used as optical compensation film, protective films for polarizing plates or the like in liquid-crystal display devices. For example, various cellulose acylate films for use in VA (vertically-aligned)-mode liquid-crystal display devices and the like have been proposed (e.g., JP-A Nos. 2003-240948, 2003-270442, 2007-3679.

The demand for reducing the thickness of liquid-crystal display devices is much increasing, and for realizing it, it is effective to reduce the thickness of various film members that constitute the liquid-crystal display device. However, retardation of a film is in proportion to the thickness thereof, and therefore, when a film is thinned, there may occur a problem in that the film could not attain the necessary optical properties.

### SUMMARY OF THE INVENTION

Objects of the invention are to provide a cellulose acylate film that has retardation enough for contributing toward reducing the thickness of liquid-crystal display devices, and enough for contributing toward the optical compensation in liquid-crystal display devices; and to provide a polarizing plate and a liquid-crystal display device comprising the film.

The means for achieving the above mentioned objects are as follows.
[1] A cellulose acylate film whose thickness is from 10 μm to 40 μm, retardation in plane at a wavelength 590 nm, Re(590), satisfies 40 nm≦Re(590)≦70 nm, and retardation along the thickness direction at a wavelength 590 nm, Rth(590), satisfies 90 nm≦Rth(590)≦150 nm; and

which comprises at least cellulose acetate propionate, cellulose acetate butyrate or cellulose acetate propionate butyrate, having a total degree of acyl substitution of from 2 to 2.35 and a degree of propionyl and/or butyryl substitution of from 0.6 to 1.1.
[2] The cellulose acylate film according to [1], which satisfies 57 nm≦Re(590)≦70 nm and 90 nm≦Rth(590)≦120 nm.
[3] The cellulose acylate film according to [1] or [2], which has a haze, Hz, of from 0% to 0.3%.
[4] The cellulose acylate film according to any one of [1] to [3], which satisfies the following two relations:

0.7<Re(450)/Re(630)<0.92,

0.7<Rth(450)/Rth(630)<0.95.
[5] The cellulose acylate film according to any one of [1] to [4], which comprises at least one compound selected from a group consisting of monomers or 2- to 10-multimers of saccharides and their derivatives in an amount of from 0.1% by mass to 20% by mass.
[6] The cellulose acylate film according to any one of [1] to [5], which comprises at least one polycondensation-ester derivative of a dicarboxylic acid component comprising at least one aromatic dicarboxylic acid and at least one aliphatic dicarboxylic acid, and an ethylene glycol and/or an aliphatic diol having from more than 2.0 to 3.0 carbon atoms on average, and wherein both terminal OH groups of the polycondensation-ester form an ester with a monocarboxylic acid.
[7] The cellulose acylate film according to [5] or [6], which satisfies the following relation:

|ΔRth|≦8 nm,

wherein |ΔRth| is an absolute value of the difference between Rth(590) of the film measured at 25 degrees Celsius and 10% RH and Rth(590) thereof measured at 25 degrees Celsius and 80% RH.
[8] The cellulose acylate film according to any one of [1] to [7], which is formed according to a solution casting method.
[9] The cellulose acylate film according to [8], which is a film stretched at a stretching ratio of from 1.4 times to 2 times in the direction perpendicular to the machine direction in film formation.
[10] The cellulose acylate film according to [9], which is a film produced through a step of blowing steam heated at 100 degrees Celsius or higher to the film stretched in the direction perpendicular to the machine direction in film formation.
[11] The cellulose acylate film according to [9] or [10], of which the modulus of tensile elasticity in an environment at 25 degrees Celsius and 60% RH in both the long side direction and the short side direction thereof is from 3500 MPa to 6000 MPa.
[12] An optical compensation film formed of a cellulose acylate film of any one of [1] to [11], or comprising a cellulose acylate film of any one of [1] to [11].
[13] A polarizing plate comprising at least a polarizing element and a cellulose acylate film of any one of [1] to [11].
[14] A liquid-crystal display device comprising at least a cellulose acylate film of any one of [1] to [11].

According to the invention, it is possible to provide a cellulose acylate film that has retardation enough for contributing toward reducing the thickness of liquid-crystal display devices, and enough for contributing toward the optical compensation in liquid-crystal display devices; and also to provide a polarizing plate and a liquid-crystal display device comprising the film.

### DETAILED DESCRIPTION OF THE INVENTION

The invention is described in detail hereinunder. Note that, in this patent specification, any numerical expressions in a style of “ . . . to . . . ” will be used to indicate a range including the lower and upper limits represented by the numerals given before and after “to”, respectively.

In this description, Re(λ) and Rth(λ) are retardation in plane (nm) and retardation along the thickness direction (nm), respectively, at a wavelength of λ. Re(λ) is measured by applying light having a wavelength of λ nm to a film in the normal direction of the film, using KOBRA 21ADH or WR (by Oji Scientific Instruments).

The selectivity of the measurement wavelength λ nm may be conducted by a manual exchange of a wavelength-filter, a program conversion of a measurement wavelength value or the like.

When a film to be analyze by a monoaxial or biaxial index ellipsoid, Rth(λ) of the film is calculated as follows.

Rth(λ) is calculated by KOBRA 21ADH or WR based on six Re(λ) values which are measured for incoming light of a wavelength λ nm in six directions which are decided by a 10° step rotation from 0° to 50° with respect to the normal direction of a sample film using an in-plane slow axis, which is decided by KOBRA 21ADH, as an inclination axis (a rotation axis; defined in an arbitrary in-plane direction if the film has no slow axis in plane); a value of hypothetical mean refractive index; and a value entered as a thickness value of the film.

In the above, when the film to be analyzed has a direction in which the retardation value is zero at a certain inclination angle, around the in-plane slow axis from the normal direction as the rotation axis, then the retardation value at the inclination angle larger than the inclination angle to give a zero retardation is changed to negative data, and then the Rth(λ) of the film is calculated by KOBRA 21ADH or WR.

Around the slow axis as the inclination angle (rotation angle) of the film (when the film does not have a slow axis, then its rotation axis may be in any in-plane direction of the film), the retardation values are measured in any desired inclined two directions, and based on the data, and the estimated value of the mean refractive index and the inputted film thickness value, Rth may be calculated according to the following formulae (A) and (B):

$$\begin{matrix}R e ( θ ) = [ nx - \frac{ny \times n z}{\sqrt{{\{ ny sin ( {sin}^{- 1} ( \frac{sin ( - θ )}{nx} ) ) \}}^{2} + {\{ nz cos ( {sin}^{- 1} ( \frac{sin ( - θ )}{nx} ) ) \}}^{2}}} ] \times \frac{d}{cos \{ {sin}^{- 1} ( \frac{sin ( - θ )}{nx} ) \}} & ( A ) \\ Rth = ( \frac{nx + ny}{2} - nz ) \times d & ( B )\end{matrix}$$

wherein Re(θ) represents a retardation value in the direction inclined by an angle θ from the normal direction; nx represents a refractive index in the in-plane slow axis direction; ny represents a refractive index in the in-plane direction perpendicular to nx; and nz represents a refractive index in the direction perpendicular to nx and ny. And “d” is a thickness of the sample.

When the film to be analyzed is not expressed by a monoaxial or biaxial index ellipsoid, or that is, when the film does not have an optical axis, then Rth(λ) of the film may be calculated as follows. The selectivity of the measurement wavelength λ nm may be conducted by a manual exchange of a wavelength-filter, a program conversion of a measurement wavelength value or the like.

Re(λ) of the film is measured around the slow axis (judged by KOBRA 21ADH or WR) as the in-plane inclination axis (rotation axis), relative to the normal direction of the film from −50 degrees up to +50 degrees at intervals of 10 degrees, in 11 points in all with a light having a wavelength of λ nm applied in the inclined direction; and based on the thus-measured retardation values, the estimated value of the mean refractive index and the inputted film thickness value, Rth(λ) of the film may be calculated by KOBRA 21ADH or WR.

In the above-described measurement, the hypothetical value of mean refractive index is available from values listed in catalogues of various optical films in Polymer Handbook (John Wiley & Sons, Inc.). Those having the mean refractive indices unknown can be measured using an Abbe refract meter. Mean refractive indices of some major optical films are listed below:

cellulose acylate (1.48), cycloolefin polymer (1.52), polycarbonate (1.59), polymethylmethacrylate (1.49) and polystyrene (1.59).

KOBRA 21ADH or WR calculates nx, ny and nz, upon enter of the hypothetical values of these mean refractive indices and the film thickness. Base on thus-calculated nx, ny and nz, Nz=(nx−nz)/(nx−ny) is further calculated.

In this description, for the data of Re, Rth and refractive index, in case where the wavelength at which they are measured is not described, the wavelength is 590 nm. In case where the environmental conditions for the measurement are not described, the data are measured in an environment at a temperature of 25 degrees Celsius and a relative humidity of 60% RH.

In this description, regarding the angle of the optical axis of an optical member (e.g., angle such as “450” or the like) and its relations (e.g., “perpendicular” or “parallel”), the data include the error range acceptable in the technical field of liquid-crystal display devices. For example, the data are meant to fall within a range of the precise angle ± less than 5°. The error from the precise angle is preferably less than 4°, more preferably less than 3°.

### 1. Cellulose Acylate Film:

### 1.-1 Properties of Cellulose Acylate Film:

The invention relates to a cellulose acylate film having a thickness of from 10 to 40 μm, Re(590) of from 40 to 70 nm, and Rth(590) of from 90 to 150 nm. The film having the optical properties is useful as an optical compensation film for reducing the light leakage occurring in oblique directions in the black states of VA-mode liquid-crystal displays. In the invention, a cellulose having a predetermined degree of acyl substitution as mentioned below is used, thereby attaining a film having Re and Rth falling within the above-mentioned range and having a thickness of equal to or less than 40 μm. As a result, the invention contributes toward enhancing the display performance of VA-mode liquid-crystal display devices and contributes toward reducing the thickness of the display devices.

The preferred range of Re(590) and Rth(590) of the cellulose acylate film of the invention differs, depending on the applications of the film. As one example, in one embodiment of using the film as a protective film for a polarizing plate for use in a VA-mode liquid-crystal display device, in which the protective film is disposed on the side of the liquid-crystal cell therein, Re(590) is preferably from 57 to 70 nm, more preferably from 61 to 70 nm. Rth(590) is preferably from 90 to 120 nm, more preferably from 100 to 115 nm.

### (Film Thickness)

The cellulose acylate film of the invention has a thickness of from 10 to 40 μm. From the viewpoint of reducing the thickness of display devices, the film thickness is preferably smaller. However, when the thickness is less than 10 μm, then the film handlability may be poor. From the viewpoint of the handlability thereof, the thickness of the cellulose acylate film is preferably at least 20 μm, more preferably at least 30 μm.

### (Haze)

Preferably, the cellulose acylate film of the invention has a low haze. The film having a low haze is preferably used in a liquid-crystal display device, as not reducing the front contrast of the display device (in the direction along the normal line of the display panel). The cellulose acylate film of the invention may have a haze reduced to 0.3% or less. Ordinary cellulose acylate films may contain a large quantity of additives or may be thick in order to have Re and Rth falling within the above-mentioned range, and it is difficult to reduce their haze to at most 0.3%. From the viewpoint of the front contrast of liquid-crystal display devices, the haze of the cellulose acylate film of the invention is more preferably equal to or less than 0.2%, even more preferably equal to or less than 0.1%.

In this description, the method of film haze measurement is as follows: A film sample of 40 mm×80 mm is prepared, and tested with a haze meter (HGM-2DP, by Suga Test Instruments) in an environment at 25 degrees Celsius and 60% RH, according to JIS K-6714.

### (Wavelength Dispersion Characteristics of Re and Rth)

In any embodiments of the above-mentioned applications, the cellulose acylate film of the invention preferably shows reversed wavelength dispersion characteristics of Re and Rth in a visible light region, or that is, preferably, their Re and Rth are smaller at a shorter wavelength. Concretely, Re(450)/Re(630) and Rth(450)/Rth(630) of the cellulose acylate film of the invention are preferably both less than 1, more preferably satisfy the following relations, (I) and (II):

0.7<Re(450)/Re(630)<0.92 (I)

0.7<Rth(450)/Rth(630)<0.95; (II)

even more preferably, the following relations, (I)′ and (II)′:

0.8<Re(450)/Re(630)<0.92 (I)′

0.8<Rth(450)/Rth(630)<0.95; (II)′

still more preferably, the following relations, (I)″ and (I)″:

0.85<Re(450)/Re(630)<0.92 (I)″

0.85<Rth(450)/Rth(630)<0.95. (II)″

### (Humidity Dependence of Rth)

Preferably, the environment-dependent fluctuation of the optical properties of the cellulose acylate film of the invention is small, for use of the film for members of liquid-crystal display devices. In particular, cellulose acylate films are moisture-permeable, and the environmental moisture-dependent fluctuation of the optical properties of the films, especially the Rth fluctuation (ΔRth) thereof is a risky factor. The cellulose acylate film of the invention is formed of a cellulose acylate material having a predetermined degree of acyl substitution, and is therefore characterized in that the environmental moisture-dependent ΔRth thereof is relatively small. Further in one embodiment of the invention where a predetermined oligomer-type plasticizer and/or saccharide-type plasticizer as described below is added to the film as an additive, the film is characterized in that the moisture-dependent Rth fluctuation (ΔRth) thereof is especially small. Concretely, the cellulose acylate film of the invention satisfies the condition that the absolute value of the difference between its Rth(590) measured at 25 degrees Celsius and 10% RH and its Rth(590) measured at 25 degrees Celsius and 80% RH, |ΔRth| is less than 15 nm; and containing a predetermined oligomer mentioned below as an additive, the film satisfies |ΔRth| of equal to or less than 8 nm, more preferably |ΔRth| of equal to or less than 6 nm, and even more preferably equal to or less than 4 nm.

In this description, Rth of the film in an environment at a predetermined temperature and a predetermined relative humidity is meant to indicate a value of Rth of a film sample measured after left in the predetermined environment for 2 hours and while kept in the same environment.

### (Modulus of Tensile Elasticity)

The mechanical properties of the cellulose acylate film of the invention are not specifically defined. The preferred range thereof may vary depending on the use of the film. In an embodiment where the film is used as a member in a liquid-crystal display device, when the modulus of tensile elasticity of the film is high, then it is favorable in that the dimensional change of polarizing plates owing to the external stress such as shrinkage thereof may be reduced; but on the other hand, when the modulus of tensile elasticity thereof is too high, then the handlability of the film is poor. From the viewpoint of the two, in the embodiment where it is used as a member in a liquid-crystal display device, preferably, the modulus of tensile elasticity of the cellulose acylate film of the invention is from 3500 to 6000 MPa in both the long side direction and the short side direction thereof in an environment at 25 degrees Celsius and 60% RH, more preferably from 4000 to 5500 MPa, even more preferably from 4500 MPa to 5200 MPa. In this description, the modulus of tensile elasticity of film is a value measured according to JIS K 7162. In an embodiment where the film is square of which the long side and the short side are not distinguished, the long side and the short side are meant to indicate the two sides perpendicularly crossing each other.

### 1.-2 Material of Cellulose Acylate:

### 1.-2-1 Cellulose Acylate:

The cellulose acylate film of the invention contains one or more cellulose acylates as the main ingredients thereof. The wording “contains as the main ingredient” as referred to herein means as follows: When the material of the cellulose acylate film is one cellulose acylate, the main ingredient is that one cellulose acylate; and when the material is comprised of plural types of cellulose acylates, then the cellulose acylate having the highest content is the main ingredient. Cellulose has 2-, 3- and 6-positioned free hydroxyl groups in one β-1,4-bonding glucose unit thereof. For the material for the cellulose acylate film of the invention, from 2 to 2.35 hydroxyl groups on average of all these three hydroxyl groups are substituted with an acyl group at the hydrogen atom thereof; and of those, from 0.6 to 1.1 hydroxyl groups are substituted with a propionyl group and/or a butyryl group. With that, cellulose acetate propionate, or cellulose acetate butyrate, or cellulose acetate propionate butyrate is used as the cellulose acylate material in the invention. When the total degree of acyl substitution is less than 2, then many unsubstituted hydroxyl groups may remain in the material, and the film formed of the material may have great humidity dependence, and if so, the film is unfavorable to applications that require durability to humidity, for example, to applications to optical members of liquid-crystal display devices. On the other hand, when the total degree of acyl substitution is more than 2.35, then the Re and Rth expressibility of the film may lower, and if so, the film having a thickness of 40 μm or less could not attain Re and Rth falling within the above-mentioned range. From the viewpoint of the two, the total degree of acyl substitution of the film is preferably from 2.1 to 2.35, more preferably from 2.2 to 2.35.

On the other hand, the degree of substitution with a propionyl group and/or a butyryl group in cellulose acylate may have an influence on the Re and Rth expressibility of the cellulose acylate film and also on the humidity dependence and the modulus of elasticity of the film. When the degree of substitution with a propionyl group and/or a butyryl group is defined to be from 0.6 to 1.1, then the film may have Re and Rth falling within the above-mentioned range. Further, when the degree of substitution with a propionyl group and/or a butyryl group is 0.6 or more, then the humidity dependence of the film may re reduced; however, when the degree of substitution is more than 1.1, then the modulus of elasticity of the film tends to lower.

In this description, the degree of acyl substitution of cellulose acylate may be computed by measuring the bonding fatty acid amount per the constitutive unit mass of cellulose. For the measurement method, referred to is “ASTM D817-91”.

Cellulose acetate propionate, or cellulose acetate butyrate, or cellulose acetate propionate butyrate, whose degree of substitution satisfies the above mentioned conditions, is preferable as the material of the cellulose acylate film of the invention.

The cellulose material for cellulose acylate includes cotton liter and wood pulp (hardwood pulp, softwood pulp), and cellulose acylate obtained from any such cellulose material is usable herein. As the case may be, those cellulose materials may be mixed for use herein. The cellulose materials are described in detail, for example, in Marusawa & Uda's “Plastic Material Lecture (17), Cellulose Resin” by Nikkan Kogyo Shinbun (1970) and Hatsumei Kyokai's Disclosure Bulletin 2001-1745 (pp. 7-8), and those celluloses described therein may be usable herein. There should not be any specific limitation to the cellulose acylate film for use in the invention.

Preferably, the cellulose acylate to be used in the invention has a mass-average degree of polymerization of from 350 to 800, more preferably from 370 to 600. Also preferably, the cellulose acylate to be used in the invention has a number-average molecular weight of from 70000 to 230000, more preferably from 75000 to 230000, even more preferably from 78000 to 120000.

The cellulose acylate may be produced, using an acid anhydride or an acid chloride as the acylating agent for it. One most general production method for producing the cellulose acylate on an industrial scale comprises esterifying cellulose obtained from cotton linter, wood pulp or the like with a mixed organic acid component comprising an organic acid corresponding to an acetyl group and other acyl group (acetic acid, propionic acid, butyric acid) or its acid anhydride (acetic anhydride, propionic anhydride, butyric anhydride).

### 1.-2-2 Additives:

The cellulose acylate film of the invention may contain at least one additive for various purposes. When the cellulose acylate film is produced according to a solution-casting method, the additive may be added to a cellulose acylate dope. The timing of addition is not specifically defined. The additive is selected from those miscible with cellulose acylate (soluble in a cellulose acylate dope in a solution-casting method). The additive is added for the purpose of controlling the optical properties of cellulose acylate and for controlling other properties thereof.

### (Plasticizer)

The cellulose acylate film of the invention preferably contains a plasticizer for enhancing the film formability. The plasticizer is preferably a saccharide plasticizer selected from a compound group of saccharides and their derivatives, or an oligomer plasticizer selected from oligomers. Containing the plasticizer of the type, the environmental moisture durability of the cellulose acylate film may be enhanced. Concretely, the plasticizer may reduce the moisture-dependent Rth fluctuation, |ΔRth| of the film; and |ΔRth| of the film measured under the above-mentioned condition may be equal to or less than 8 nm. When both the saccharide plasticizer and the oligomer plasticizer are added as combined, they are more effective for reducing |ΔRth| of the film.

### (Saccharide Plasticizer)

As described in the above, the cellulose acylate film of the invention contains at least one compound selected from a compound group of saccharides and their derivatives. Above all, compounds selected from a compound group consisting of monomers or 2- to 10-multimers of saccharides and their derivatives in an amount of from 0.1% by mass to 20% by mass are preferred as the plasticizer. Their examples include saccharide derivatives where the hydrogen atom of OH in a saccharide such as glucose is partly or wholly substituted with an acyl group, as in WO2007/125764, [0042] to [0065]. The amount of the saccharide plasticizer to be added is preferably from 0.1% by mass to less than 20% by mass of the main ingredient, cellulose acylate, more preferably from 0.1% by mass to less than 10% by mass, even more preferably from 0.1% by mass to less than 7% by mass.

### (Oligomer Plasticizer)

As described in the above, the cellulose acylate film of the invention preferably contains an oligomer plasticizer selected from oligomers. Preferred examples of the oligomer plasticizer include polycondensation-esters of a diol component and a dicarboxylic acid compound and their derivatives (hereinafter this may be referred to as “polycondensation-ester plasticizer”), and oligomers of methyl acrylate (MA) and their derivatives (hereinafter this may be referred to as “MA oligomer plasticizer”).

The polycondensation-esters are those of a dicarboxylic acid component and a diol component. The dicarboxylic acid component may be one dicarboxylic acid or a mixture of two or more dicarboxylic acids. Above all, at least one aromatic dicarboxylic acid and at least one aliphatic dicarboxylic acid are preferably used as the dicarboxylic acid component. On the other hand, the diol component may also be one diol component or a mixture of two or more diols. Above all, as the diol component, preferred is ethylene glycol and/or an aliphatic diol having from more than 2.0 to 3.0 carbon atoms on average.

The ratio of the aromatic dicarboxylic acid to the aliphatic dicarboxylic acid in the carboxylic acid component is preferably such that the aromatic dicarboxylic acid accounts for from 5 to 70 mol %. Within the range, the environmental moisture dependence of the optical properties of the film may be reduced, and during the film formation, the plasticizer may be prevented from bleeding out. The aromatic dicarboxylic acid in the dicarboxylic acid component more preferably accounts for from 10 to 60 mol %, even more preferably from 20 to 50 mol %.

Examples of the aromatic dicarboxylic acid include phthalic acid, terephthalic acid, isophthalic acid, 1,5-naphthalene dicarboxylic acid, 1,4-naphthalene dicarboxylic acid, 1,8-naphthalene dicarboxylic acid, 2,8-naphthalene dicarboxylic acid and 2,6-naphthalene dicarboxylic acid; and among these, phthalic acid and terephthalic acid are preferable. Examples of the aliphatic dicarboxylic acid include oxalic acid, malonic acid, succinic acid, maleic acid, fumaric acid, glutaric acid, adipic acid, pimelic acid, suberic acid, azelaic acid, sebacic acid, dodecane dicarboxylic acid, and 1,4-cyclohexane dicarboxylic acid; and among these, succinic acid and adipic acid are preferable.

The diol component may be ethylene glycol and/or an aliphatic diol having from more than 2.0 to 3.0 carbon atoms on average. The molar ratio of ethylene glycol is preferably equal to or more than 50 mol % and more preferably equal to or more than 75 mol % with respect to the total mole of the diol component. Examples of aliphatic diol include alkyl diols and alicyclic diols such as ethylene glycol, 1,2-propanediol, 1,3-propanediol, 1,2-butanediol, 1,3-butanediol, 2-methyl-1,3-propanediol, 1,4-butanediol, 1,5-pentanediol, 2,2-dimethyl-1,3-propanediol(neopentyl glycol), 2,2-diethyl-1,3-propanediol(3,3-dimethyrol pentane), 2-n-butyl-2-ethyl-1,3-propanediol(3,3-dimethyrol heptane), 3-methyl-1,5-pentanediol, 1,6-hexanediol, 2,2,4-trimethyl-1,3-pentanediol, 2-ethyl-1,3-hexanediol, 2-methyl-1,8-octanediol, 1,9-nonanediol, 1,10-decanediol, 1,12-octadecanediol and diethylene glycol; and one or more selected from these are preferably used along with ethylene glycol. The diol component is preferably ethylene glycol, 1,2-propanediol or 1,3-propanediol, and more preferably ethylene glycol or 1,2-propanediol.

The polycondensation-ester plasticizer is preferably a polycondensation-ester derivative in which the terminal OH of the polycondensate ester forms an ester with a monocarboxylic acid. The monocarboxylic acid for use for blocking both terminal OH groups is preferably an aliphatic monocarboxylic acid, more preferably acetic acid, propionic acid, butanoic acid, benzoic acid and their derivatives, etc., even more preferably acetic acid or propionic acid, most preferably acetic acid. When the number of the carbon atoms constituting the monocarboxylic acid for use for both terminals of the polycondensate ester is equal to or less than 3, then the heating loss of the compound is not large and the surface defectives in the film may be reduced. A mixture of two or more different types of monocarboxylic acids may be used for terminal blocking. Preferably, both terminals of the polycondensation-ester are blocked with acetic acid or propionic acid, and more preferably, they are blocked with acetic acid to give polycondensation-ester derivatives having an acetyl ester residue at both terminals.

The polycondensation-esters and their derivatives are preferably oligomers having a number-average molecular weight of from 700 to 2000 or so, more preferably from 800 to 1500 or so, even more preferably from 900 to 1200 or so. The number-average molecular weight of the polycondensation-ester may be measured and evaluated through gel permeation chromatography.

Examples of he polycondensation-ester plasitizer include, but are not limited to, those shown below.

| | Dicarboxylic acid | | | Diol | | | | |
|---|---|---|---|---|---|---|---|---|
| | | | Ratio | | | mean | | |
| | | | of | | | number of | | Number- |
| | Aromatic | Aliphatic | dicarboxylic | | Ratio of | carbon | | averaged |
| | dicarboxylic | dicarboxylic | acids | Aliphatic | diol(s) | atom(s) in | Both | molecular |
| | acid | acid | (mol %) | diol | (mol %) | diol(s) | terminals | weight |
| P-1 | PA | AA | 10/90 | Ethylene | 100 | 2.0 | Acetyl | 1000 |
| | | | | glycol | | | ester | |
| | | | | | | | residue | |
| P-2 | PA | AA | 25/75 | Ethylene | 100 | 2.0 | Acetyl | 1000 |
| | | | | glycol | | | ester | |
| | | | | | | | residue | |
| P-3 | PA | AA | 50/50 | Ethylene | 100 | 2.0 | Acetyl | 1000 |
| | | | | glycol | | | ester | |
| | | | | | | | residue | |
| P-4 | PA | SA | 5/95 | Ethylene | 100 | 2.0 | Acetyl | 1000 |
| | | | | glycol | | | ester | |
| | | | | | | | residue | |
| P-5 | PA | SA | 20/80 | Ethylene | 100 | 2.0 | Acetyl | 1000 |
| | | | | glycol | | | ester | |
| | | | | | | | residue | |
| P-6 | TPA | AA | 15/85 | Ethylene | 100 | 2.0 | Acetyl | 1000 |
| | | | | glycol | | | ester | |
| | | | | | | | residue | |
| P-7 | TPA | AA | 50/50 | Ethylene | 100 | 2.0 | Acetyl | 1000 |
| | | | | glycol | | | ester | |
| | | | | | | | residue | |
| P-8 | TPA | SA | 5/95 | Ethylene | 100 | 2.0 | Acetyl | 1000 |
| | | | | glycol | | | ester | |
| | | | | | | | residue | |
| P-9 | TPA | SA | 10/90 | Ethylene | 100 | 2.0 | Acetyl | 1000 |
| | | | | glycol | | | ester | |
| | | | | | | | residue | |
| P-10 | TPA | SA | 15/85 | Ethylene | 100 | 2.0 | Acetyl | 1000 |
| | | | | glycol | | | ester | |
| | | | | | | | residue | |
| P-11 | TPA | SA | 50/50 | Ethylene | 100 | 2.0 | Acetyl | 1000 |
| | | | | glycol | | | ester | |
| | | | | | | | residue | |
| P-12 | TPA | SA | 70/30 | Ethylene | 100 | 2.0 | Acetyl | 1000 |
| | | | | glycol | | | ester | |
| | | | | | | | residue | |
| P-13 | TPA/PA | AA | 10/10/80 | Ethylene | 100 | 2.0 | Acetyl | 1000 |
| | | | | glycol | | | ester | |
| | | | | | | | residue | |
| P-14 | TPA/PA | AA | 20/20/60 | Ethylene | 100 | 2.0 | Acetyl | 1000 |
| | | | | glycol | | | ester | |
| | | | | | | | residue | |
| P-15 | TPA/PA | AA/SA | 10/10/ | Ethylene | 100 | 2.0 | Acetyl | 1000 |
| | | | 40/40 | glycol | | | ester | |
| | | | | | | | residue | |
| P-16 | TPA | AA/SA | 10/30/60 | Ethylene | 100 | 2.0 | Acetyl | 1000 |
| | | | | glycol | | | ester | |
| | | | | | | | residue | |
| P-17 | TPA | AA/SA | 10/30/60 | Ethylene | 50/50 | 2.5 | Acetyl | 1000 |
| | | | | glycol/ | | | ester | |
| | | | | 1,2-propanediol | | | residue | |
| P-18 | TPA | AA/SA | 10/30/60 | 1,2-propanediol | 100 | 3.0 | Acetyl | 1000 |
| | | | | | | | ester | |
| | | | | | | | residue | |
| P-19 | TPA | AA/SA | 10/30/60 | Ethylene | 100 | 2.0 | Acetyl | 700 |
| | | | | glycol | | | ester | |
| | | | | | | | residue | |
| P-20 | TPA | AA/SA | 10/30/60 | Ethylene | 100 | 2.0 | Acetyl | 850 |
| | | | | glycol | | | ester | |
| | | | | | | | residue | |
| P-21 | TPA | AA/SA | 10/30/60 | Ethylene | 100 | 2.0 | Acetyl | 1200 |
| | | | | glycol | | | ester | |
| | | | | | | | residue | |
| P-22 | TPA | AA/SA | 10/30/60 | Ethylene | 100 | 2.0 | Acetyl | 1600 |
| | | | | glycol | | | ester | |
| | | | | | | | residue | |
| P-23 | TPA | AA/SA | 10/30/60 | Ethylene | 100 | 2.0 | Acetyl | 2000 |
| | | | | glycol | | | ester | |
| | | | | | | | residue | |
| P-24 | TPA | AA/SA | 10/30/60 | Ethylene | 100 | 2.0 | Propionyl | 1000 |
| | | | | glycol | | | ester | |
| | | | | | | | residue | |
| P-25 | TPA | AA/SA | 10/30/60 | Ethylene | 100 | 2.0 | Butanoyl | 1000 |
| | | | | glycol | | | ester | |
| | | | | | | | residue | |
| P-26 | TPA | AA/SA | 10/30/60 | Ethylene | 100 | 2.0 | Benzoyl | 1000 |
| | | | | glycol | | | ester | |
| | | | | | | | residue | |
| P-27 | iPA | AA/SA | 20/40/40 | Ethylene | 100 | 2.0 | Acetyl | 1000 |
| | | | | glycol | | | ester | |
| | | | | | | | residue | |
| P-28 | 2,6-NPA | AA/SA | 20/40/40 | Ethylene | 100 | 2.0 | Acetyl | 1200 |
| | | | | glycol | | | ester | |
| | | | | | | | residue | |
| P-29 | 1,5-NPA | AA/SA | 20/40/40 | Ethylene | 100 | 2.0 | Acetyl | 1200 |
| | | | | glycol | | | ester | |
| | | | | | | | residue | |
| P-30 | 1,4-NPA | AA/SA | 20/40/40 | Ethylene | 100 | 2.0 | Acetyl | 1200 |
| | | | | glycol | | | ester | |
| | | | | | | | residue | |
| P-31 | 1,8-NPA | AA/SA | 20/40/40 | Ethylene | 100 | 2.0 | Acetyl | 1200 |
| | | | | glycol | | | ester | |
| | | | | | | | residue | |
| P-32 | 2,8-NPA | AA/SA | 20/40/40 | Ethylene | 100 | 2.0 | Acetyl | 1200 |
| | | | | glycol | | | ester | |
| | | | | | | | residue | |

* 1) PA: phthalic acid; TPA: terephthalic acid; IPA: isophthalic acid; AA: adipic acid; SA: succinic acid; 2,6-NPA: 2,6-naphthalene dicarboxylic acid; 2,8-NPA: 2,8-naphthalene dicarboxylic acid; 1,5-NPA: 1,5-naphthalene dicarboxylic acid; 1,4-NPA: 1,4-naphthalene dicarboxylic acid; 1,8-NPA: 1,8-naphthalene dicarboxylic acid

The polycondensation-ester can be produced with ease according to any conventional method, for example, according to a polyesterification, interesterification or thermal-fusing condensation method of a dicarboxylic acid component and a diol component, or an interfacial condensation method of an acid chloride of a dicarboxylic acid component and a glycol. Polycondensate esters usable in the invention are described in detail in Koichi Murai, “Plasticizers and their Theory and Applications” (by Miyuki Shobo, 1st Ed., issued on Mar. 1, 1973). In addition, also usable herein are materials described JP-A Nos. 5-155809, 5-155810, 5-197073, 2006-259494, 7-330670, 2006-342227, and 2007-3679.

The amount of the polycondensation-ester plasticizer to be added is preferably from 0.1 to 25% by mass of the amount of the main ingredient, cellulose acylate, more preferably from 1 to 20% by mass, even more preferably from 3 to 15% by mass.

The content of the starting materials and the side products in the polycondensation-ester plasticizer, concretely aliphatic diols, dicarboxylates, diol esters and others, that may be in the film is preferably less than 1%, more preferably less than 0.5%. The dicarboxylate includes dimethyl phthalate, di(hydroxyethyl)phthalate, dimethyl terephthalate, di(hydroxyethyl)terephthalate, di(hydroxyethyl)adipate, di(hydroxyethyl)succinate, etc. The diol ester includes ethylene diacetate, propylene diacetate, etc.

As the plasticizer for the cellulose acylate film of the invention, also preferred is a methyl methacrylate (MA) oligomer plasticizer. The MA oligomer plasticizer may be combined with the above-mentioned saccharide plasticizer for use herein. In the mode of combination use, the ratio by mass of the MA oligomer plasticizer to the saccharide plasticizer is preferably from ½ to ⅕, more preferably from ⅓ to ¼.

Examples of the MA-oligomer plasticizer include oligomers having a repeating unit shown below.

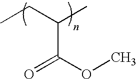

The weight-averaged molecular weight is preferably from about 500 to about 2000, more preferably from about 700 to about 1500; and more preferably from about 800 to about 1200.

Examples of the MA-oligomer plasticizer include both of oligomers of MA alone and oligomers having other repeating unit(s) along with the representing unit derived from MA. Examples of the other repeating unit(s) include any units derive from ethyl acrylate, i- or n-propyl acrylate, n-, i-, s- or t-butyl acrylate, n-, i- or s-pentyl acrylate, n- or i-hexyl acrylate, n- or i-heptyl acrylate, n- or i-octyl acrylate, n- or i-nonyl acrylate, n- or i-myristyl acrylate, 2-ethylhexyl acrylate, ε-caprolactam acrylate, 2-hydroxyethyl acylate, 2-hydroxypropyl acrylate, 3-hydroxypropyl acrylate, 4-hydroxybutyl acrylate, 2-hydroxybutyl acrylate, 2-methoxyethyl acrylate, 2-ethoxyethyl acrylate and methacrylates formed by replacing acrylic acid in the acrylates with methacrylic acid. Monomers having an aromatic ring(s) such as styrene, methyl styrene and hydroxy styrene may be used. As the other monomer(s), acrylate monomer(s) or methacrylate monomer(s), having no aromatic ring, are preferable.

The MA-oligomer plasticizer, having two or more repeating units derived from X which is a monomer having a hydrophilic group(s) and from Y which is a monomer having no hydrophilic group, may be used. Among such oligomers, those having a molar ratio of X to Y, X/Y, of from 1/1 to 1/99 are preferable.

The MA-oligomer may be prepared in reference to the method described in JP-A No. 2003-12859.

### (Polymer Plasticizer)

The cellulose acylate film of the invention may contain any other polymer plasticizer along with or in place of any one of the above-mentioned saccharide plasticizer, polycondensate ester plasticizer and MA oligomer plasticizer. The other polymer plasticizer includes polyester-polyurethane plasticizers, aliphatic hydrocarbon polymers, alicyclic hydrocarbon polymers; vinylic polymers such as polyvinyl isobutyl ether, poly-N-pyrrolidone, etc.; styrenic polymers such as polystyrene, poly-4-hydroxystyrene, etc.; polyethers such as polyethylene oxide, polypropylene oxide, etc.; polyamides, polyurethanes, polyureas, phenol-formaldehyde condensates, urea-formaldehyde condensates, polyvinyl acetate, etc.

### (Compound Having at Least Two Aromatic Rings)

The cellulose acylate film of the invention may contain a compound having at least 2 aromatic rings. The compound has an effect of controlling the optical properties of the cellulose acylate film. For example, when the cellulose acylate film of the invention is sued as an optical compensation film, it is effectively stretched for controlling the optical properties, especially Re thereof to be on a desired level. For increasing Re thereof, the in-plane refractive anisotropy of the film may be increased, for which one method comprises regulating the main chain orientation by stretching. As combined with stretching, a compound having a large refractivity anisotropy may be added to the film for further increasing the refractive anisotropy of the film. For example, when the film to which a compound having at least 2 aromatic ring is added as an additive thereto is stretched, the main chain of the polymer constituting the film is oriented, and with that, the compound itself becomes well orientable and the film may be controlled to have desired optical properties with ease.

The compound having at least 2 aromatic rings includes, for example, triazine compounds as in JP-A 2003-344655, rod-shaped compounds as in JP-A 2002-363343, crystalline compounds as in JP-A 2005-134884 and 2007-119737, etc. More preferred are triazine compounds and rod-shaped compounds. Two or more different types of compounds having at least 2 aromatic rings may be used, as combined. The molecular weight of the compound having at least 2 aromatic rings is preferably from 300 to 1200 or so, more preferably from 400 to 1000.

The amount of the compound having at least 2 aromatic rings to be added is preferably from 0.05% to 10% in terms of the ratio by mass to cellulose acylate, more preferably from 0.5% to 8%, even more preferably from 1% to 5%.

### (Optical Anisotropy-Controlling Agent)

An optical anisotropy-controlling agent may be added to the cellulose acylate film. For example, its examples include “Rth-reducing compounds” described in JP-A 2006-30937, pp. 23-72.

### (Wavelength Dispersion Characteristics-Controlling Agent)

A compound capable of suppressing the wavelength dispersion characteristics of retardation (hereinafter this may be referred to as “wavelength dispersion characteristics-controlling agent”) may be added to the cellulose acylate film. The wavelength dispersion characteristics-controlling agent is a compound having an absorption in a UV region of from 200 to 400 nm wavelength and capable of reducing |Re(400)−Re(700)| and |Rth(400)−Rth(700)| of the film. When the agent is added to the cellulose acylate film in an amount of from 0.01 to 30% by mass of the solid content of the cellulose acylate, then the wavelength dispersion characteristics of Re and Rth of the cellulose acylate film can be suppressed.

For example, the wavelength dispersion characteristics of retardation of a cellulose acylate film are generally such that Re and Rth of the film are larger on the long wavelength side than on the short wavelength side. Accordingly, by controlling the film to have larger Re and Rth relatively on the short wavelength side in a visible light region, on which they are generally small, the wavelength dispersion characteristics of retardation of the film may be smoothed. On the other hand, the wavelength dispersion characteristics of retardation of a compound having an absorption in a UV region of from 200 o 400 nm wavelength are such that the absorbance of the compound is larger on the long wavelength side than on the short wavelength side. In case where the compound itself exits isotropically inside the film, then it may be considered that the birefringence of the compound itself and even the wavelength dispersion characteristics of Re and Rth of the film could be smaller on the short wavelength side like the dispersion wavelength characteristics of the absorbance of the film. Accordingly, when a compound which has an absorption within a UV region of from 200 to 400 nm wavelength and which is such that the wavelength dispersion characteristics of Re and Rth of the film isotropically containing the compound are considered larger on the short wavelength side, is added to a cellulose acylate film, then the wavelength dispersion characteristics of Re and Rth of the cellulose acylate film can be flattened. The compound usable as a wavelength dispersion characteristics-controlling agent is required to be fully and uniformly miscible in cellulose acylate, in addition to having the above-mentioned properties. The UV absorption zone range of the compound usable as the wavelength dispersion characteristics-controlling agent is preferably from 200 to 400 nm, more preferably from 220 to 395 nm, even more preferably from 240 to 390 nm.

Recently, in liquid-crystal display devices for televisions, notebook-size personal computers, mobile telephone terminals and others, the transmittance of the optical members constituting the devices is required to be excellent for the purpose of increasing the brightness of the devices driven with a smaller power. From this viewpoint, the compound to be used as the wavelength dispersion characteristics-controlling agent in the invention is required not to lower the spectral transmittance of the film. In these applications, the cellulose acylate film of the invention preferably has a spectral transmittance at a wavelength of 380 nm of from 45% to 95%, and a spectral transmittance at a wavelength of 350 nm of at most 10%.

Preferably, the molecular weight of the wavelength dispersion characteristics-controlling agent is equal to or more than 250 in order that the agent does not evaporate away during film formation. More preferably, the molecular weight is equal to or more than 260, even more preferably equal to or more than 270, still more preferably equal to or more than 300. Having the molecular weight falling within the range, the agent may be a monomer, or an oligomer or a polymer comprising a plurality of such monomer units.

Specific examples of the wavelength dispersion characteristics-controlling agent preferred for use in the invention include benzotriazole compounds, benzophenone compounds, cyano group-containing compounds, oxybenzophenone compounds, salicylate compounds, nickel complex compounds, etc., to which, however, the invention should not be limited. One or more such wavelength dispersion characteristics-controlling agents may be used herein either singly or as combined in any desired ratio.

The amount of the wavelength dispersion characteristics-controlling agent to be added is preferably from 0.01 to 30% by mass or so relative to cellulose acylate, more preferably from 0.1 to 20% by mass, further more preferably from 0.2 to 10% by mass or so.

### (Mat Agent Fine Particles)

The cellulose acylate-base film of the invention may contain fine particles as a mat agent. The fine particles usable in the invention are silicon dioxide, titanium dioxide, aluminium oxide, zirconium oxide, calcium carbonate, talc, clay, calcined kaolin, calcined calcium silicate, calcium silicate hydrate, aluminium silicate, magnesium silicate, and calcium phosphate. Preferably, the fine particles contain silicon as they are effective for reducing the haze of films. Especially preferably, they are silicon dioxide. It is desirable that the silicon dioxide fine particles have a primary mean particle size of at most 20 nm and an apparent specific gravity of at least 70 g/liter. More preferably, the mean particle size of the primary particles is small, falling between 5 and 16 nm, as they are effective for reducing the haze of the film. More preferably, the apparent specific gravity is from 90 to 200 g/liter, even more preferably from 100 to 200 g/liter. The particles having a larger apparent specific gravity may make it easier to form a dispersion having a higher concentration, and they are desirable as reducing the film haze and as preventing the formation of aggregates of the particles in the film.

The fine particles generally form secondary particles having a mean particle size of from 0.1 to 3.0 μm, and they exist as aggregates of their primary particles in the film, therefore forming projections having a size of from 0.1 to 3.0 μm in the film surface. The secondary mean particle size is preferably from 0.2 μm to 1.5 μm, more preferably from 0.4 μm to 1.2 μm, most preferably from 0.6 μm to 1.1 μm. The primary and secondary particle sizes are the diameters of the circumscribed circles of the particles in the film observed with a scanning electronic microscope. Concretely, 200 particles in different sites are observed and analyzed, and their mean value is the mean particle size.

As fine particles of silicon dioxide, for example, commercial products of Aerosil R972, R972V, R974, R812, 200, 200V, 300, R202, OX50, TT600 (all by Nippon Aerosil) are usable. As fine particles of zirconium oxide, for example, commercial products of Aerosil R976 and R811 (both by Nippon Aerosil) are usable.

Of those, Aerosil 200V and Aerosil R972V are fine particles of silicon dioxide having a primary mean particle size of at most 20 nm and having an apparent specific gravity of at least 70 g/liter, and these are especially preferred as they are effective for reducing the friction factor of optical films while keeping the haze of the films low.

One example of the method for preparing particles having a small secondary-particle diameter is carried out using a dispersion of fine particles. The dispersion may be prepared according to some methods. One example is as follows. A dispersion of fine particles is prepared by mixing solvent and fine particles and then stirred the mixture. And the fluid dispersion is added to a small amount of cellulose acylate solution, which is prepared separately, under stirring. Then, the mixture is mixed with a dope fluid of cellulose acylate, that is, a main ingredient. This method is preferable since fine particles of silica dioxide are well dispersed and hardly aggregate each other. Another example is as follows. A small amount of cellulose acylate is added to solvent, and stirred. Then fine particles are added to the mixture and then mixed by using a disperser to prepare “a fine-particle additional fluid”. The fine-particle additional fluid is mixed with a dope fluid fully by using in-line mixer. Any method of them may be adapted, and the method is not limited to the above mentioned methods. Preferably, the concentration of silica dioxide fine particles to be mixed and dispersed in a solvent to prepare a dispersion of the particles is from 5 to 30% by mass, more preferably from 10 to 25% by mass, even more preferably from 15 to 20% by mass. The dispersion concentration is preferably higher, as the liquid turbidity could be smaller relative to the amount of the particles in the dispersion, the haze of the film could be lower and the content of the aggregates in the film could be smaller. The amount of the mat agent to be finally in the polymer dope solution is preferably from 0.01 to 1 g per 1 m², more preferably from 0.03 to 0.3 g per 1 m², and even more preferably from 0.08 to 0.16 g per 1 m².

For mixing the mat agent with other ingredients, an in-line mixer may be used. Preferably, the concentration of silicon dioxide fine particles to be mixed and dispersed in a solvent to prepare a dispersion of the particles is from 5 to 30% by mass, more preferably from 10 to 25% by mass, most preferably from 15 to 20% by mass. The dispersion concentration is preferably higher, as the liquid turbidity could be smaller relative to the amount of the particles in the dispersion, the haze of the film could be lower and the content of the aggregates in the film could be smaller. The amount of the mat agent to be finally in the polymer dope solution is preferably from 0.001 to 1.0% by mass, more preferably from 0.005 to 0.5% by mass, and even more preferably from 0.01 to 0.1% by mass.

Examples of the solvent to be used in the method described above include lower alcohols such as methyl alcohol, ethyl alcohol, propyl alcohol, isopropyl alcohol, butyl alcohol. The other solvents than such lower alcohols are not specifically defined for use herein. Preferably, the solvents generally used in film formation from cellulose acylates may be used.

### (Low-Molecular Plasticizer, Degradation Inhibitor, Release Agent)

Various additives (e.g., low-molecular plasticizer, UV inhibitor, degradation inhibitor, release agent, IR absorbent, etc.) may be added to the cellulose acylate film in the process of producing the film, depending on the applications of the film. The additives may be solid or oily, or that is, they are not specifically defined in point of their melting point and boiling point thereof. For example, for the additive, UV absorbents at 20 degrees Celsius or lower and at 20 degrees Celsius or higher may be mixed, or plasticizers may also be mixed in the same manner. For example, these are described in JP-A 201-151901. IR absorbent dyes are described in, for example, JP-A 2001-194522. The time at which the additive is added may be in any stage in the step of dope preparation; however, the additive may be added in the final stage of the dope preparation step. Not specifically defined, the amount of the material to be added may be any one capable expressing the function thereof. In case where the cellulose acylate film is formed of plural layers, then the type and the amount of the additive to be added to the constitutive layers may differ. For example, as in JP-A 2001-151902, the related technique is known in the art. Regarding the details of the additives, the materials described in Hatsumei Kyokai Disclosure Bulletin No. 2001-1745 (published in Mar. 15, 2001 by Hatsumei Kyokai) in p.p. 16-22 are preferred for use in the invention.

### 1.-3 Production Method for Cellulose Acylate Film:

The cellulose acylate film of the invention is preferably produced according to a solution-casting method (solvent-casting method). According to a solvent-casting method, a predetermined cellulose acylate is dissolved in an organic solvent to prepare a dope, and the resulting dope is cast onto the surface of a support formed of a metal or the like, and dried into a film, and thereafter the film is peeled away from the support surface, and optionally stretched to give the cellulose acylate film of the invention.

### (Solvent-Casting Method)

In a solvent-casting method, a cellulose acylate is dissolved in an organic solvent to prepare a solution (dope), and this is formed into a film. The solvent for use in preparing the dope may be selected from an organic solvent. Preferably, the organic solvent includes at lest one selected from ethers having from 3 to 12 carbon atoms, ketones having from 2 to 12 carbon atoms, esters having from 3 to 12 carbon atoms, and halogenohydrocarbons having from 1 to 6 carbon atoms.

The esters, the ketones and the ethers may have a cyclic structure. Compounds having two or more functional groups of esters, ketones and ethers (i.e., —O—, —CO— and —COO—) are also usable herein as a main solvent; and they may have any other functional group such as an alcoholic hydroxyl group. In case where the main solvent has two or more functional groups, the number of the carbon atoms constituting them may fall within a range of the number of carbon atoms that constitute the compound having any of those functional groups

Examples of the ethers having from 3 to 12 carbon atoms are diisopropyl ether, dimethoxymethane, dimethoxyethane, 1,4-dioxane, 1,3-dioxolane, tetrahydrofuran, anisole and phenetole.

Examples of the ketones having from 3 to 12 carbon atoms are acetone, methyl ethyl ketone, diethyl ketone, diisobutyl ketone, cyclohexanone, and methylcyclohexanone.

Examples of the esters having from 3 to 12 carbon atoms are ethyl formate, propyl formate, pentyl formate, methyl acetate, ethyl acetate, and pentyl acetate.

Examples of the organic solvents having plural functional groups are 2-ethoxyethyl acetate, 2-methoxyethanol, and 2-butoxyethanol.

The halogenated hydrocarbon preferably has one or two carbon atoms, and more preferably has one carbon atom. The halogen atom of the halogenated hydrocarbon preferably is chlorine. The ratio of the substitution of hydrogen with halogen is preferably in the range of 25 to 75 mol %, more preferably in the range of 30 to 70 mol %, further preferably in the range of 35 to 65 mol %, and most preferably in the range of 40 to 60 mol %. Methylene chloride is a representative halogenated hydrocarbon.

Two or more organic solvents can be used in combination.

A cellulose acylate solution can be prepared according to a general method. The general method means that the solution is prepared at a temperature of not lower than 0 degree Celsius (ordinary or elevated temperature). The preparation of the solution can be conducted by using a process and apparatus for preparation of a dope in a general solvent casting method. The general method preferably uses a halogenated hydrocarbon (particularly methylene chloride) as an organic solvent.

The amount of cellulose acylate is so adjusted that a prepared solution contains cellulose acylate in an amount of 10 to 40% by mass. The amount of cellulose acylate more preferably is 10 to 30% by mass. An optional additive (described below) can be added to an organic solvent.

The solution can be prepared by stirring cellulose acylate and an organic solvent at an ordinary temperature (0 to 40 degrees Celsius). A solution of a high concentration is preferably prepared by stirring them at an elevated temperature and at a high pressure. In more detail, cellulose acylate and the organic solvent are placed in a closed vessel, and are stirred at an elevated temperature and at a high pressure, which is higher than the boiling point of the solvent at atmospheric pressure and is lower than the boiling point of the solvent at the high pressure. The heating temperature is usually not-lower than 40 degrees Celsius, preferably in the range of 60 to 200 degrees Celsius, and more preferably in the range of 80 to 110 degrees Celsius.

The ingredients may be put into a chamber, after roughly mixed. They may be put into a chamber successively. The chamber must be so designed that the contents may be stirred therein. An inert gas such as nitrogen gas may be introduced into the chamber and the chamber may be pressurized. As the case may be, the chamber may be heated to increase the vapor pressure of the solvent, and the pressure increase may be utilized in stirring the contents of the chamber. If desired, after the chamber is closed airtightly, the ingredients may be added thereinto under pressure.

In heating it, preferably, the chamber is heated outside it. For example, a jacket-type heater may be used. A plate heater may be provided outside the chamber, and a liquid may be circulated in the pipe fitted to the heater to thereby heat the whole of the chamber.

Preferably, a stirring blade may be disposed inside the chamber, with which the contents of the chamber may be stirred. Preferably, the length of the stirring blade may reach near the wall of the chamber. Also preferably, the tip of the stirring blade may be provided with a scraper so as to renew the liquid film on the inner wall of the chamber.

The chamber may be provided with instruments such as pressure gauze, thermometer, etc. In the chamber, the ingredients are dissolved in a solvent. The thus-prepared dope is taken out of the chamber after cooled, or after taken out, it may be cooled with a heat exchanger or the like.

The solution may also be prepared according to a cooling and dissolving method. In the cooling and dissolving method, cellulose acylate may be dissolved even in an organic solvent in which it is hardly dissolved in an ordinary dissolving method. Even a solvent in which cellulose acylate can be dissolved in an ordinary dissolving method may enjoy the advantage of the cooling dissolving method capable of rapidly producing a uniform solution.

According to the cooling dissolution method, at first, cellulose acylate is gradually added to an organic solvent while stirring at room temperature.

The amount of cellulose acylate is in the range of 10 to 40% by mass, based on the amount of the mixture. The amount is preferably in the range of 10 to 30% by mass. An optional additive (described below) may be added to the solvent.

At the next stage, the mixture is cooled to a temperature of −100 to −10 degrees Celsius, preferably −80 to −10 degrees Celsius, more preferably −50 to −20 degrees Celsius, and most preferably −50 to −30 degrees Celsius. The mixture can be cooled in a dry ice/methanol bath (−75 degrees Celsius) or in a cooled diethylene glycol solution (−30 to −20 degrees Celsius). At the cooling stage, the mixture of cellulose acylate and the solvent generally solidify.

The cooling rate is preferably faster than 4 degrees Celsius per minute, more preferably faster than 8 degrees Celsius per minute, and most preferably faster than 12 degrees Celsius per minute. The cooling rate is preferably fast as possible. However, a theoretical upper limit of the cooling rate is 10,000 degree. C. per second, a technical upper limit is 1,000 degrees Celsius per second, and a practical upper limit is 100 degrees Celsius per second. The cooling rate means the change of temperature at the cooling stage per the time taken to complete the cooling stage. The change of temperature means the difference between the temperature at which the cooling stage is started and the temperature at which the cooling stage is completed.

Subsequently, the mixture is warmed to a temperature of 0 to 200 degrees Celsius, preferably 0 to 150 degrees Celsius, more preferably 0 to 120 degrees Celsius, and most preferably 0 to 50 degrees Celsius to dissolve the cellulose acylate in the solvent. The mixture can be warmed by keeping it at room temperature. The mixture can also be warmed on a bath.

The warming rate is preferably faster than 4 degrees Celsius per minute, more preferably faster than 8 degrees Celsius per minute, and most preferably faster than 12 degrees Celsius per minute. The warming rate is preferably fast as possible. However, a theoretical upper limit of the warming rate is 10,000 degrees Celsius per second, a technical upper limit is 1,000 degrees Celsius per second, and a practical upper limit is 100 degrees Celsius per second. The warming rate means the change of temperature at the warming stage per the time taken to complete the warming stage. The change of temperature means the difference between the temperature at which the warming stage is started and the temperature at which the warming stage is completed.

Thus a dope is formed as a uniform solution. If cellulose acylate is not sufficiently dissolved, the cooling and warming steps can be repeated. The dope is observed with eyes to determine whether cellulose acylate is sufficiently dissolved or not.

A sealed vessel is preferably used in the cooling dissolution method to prevent contamination of water, which is caused by dew condensation at the cooling step. The time for the cooling and warming stages can be shortened by conducting the cooling step at a high pressure and conducting the warming step at a low pressure. A pressure-resistance vessel is preferably used for applying a high or low pressure.

In the case that cellulose acetae (acetic acid content: 60.9%, viscosity average degree of polymerization: 299) is dissolved in methyl acylate by a cooling dissolution method to form 20% by mass solution, the solution has a pseudo sol-gel phase transition point at about 33 degrees Celsius, which is measured by a differential scanning calorimeter (DSC). Under the transition point, the solution forms a uniform gel. Therefore, the solution should be stored at a temperature higher than the transition point, preferably at a temperature about 10 degrees Celsius higher than the point. The pseudo sol-gel phase transition point depends on the combined average acetic acid content of cellulose acylate, the viscosity average degree of polymerization, the concentration of the dope and the nature of the solvent.

The obtained cellulose acetate solution (dope) is cast on a support, and the solvent is evaporated to form a cellulose acetate film. any retardation enhancer may be added to the dope.

The dope is cast on a drum or a band, and the solvent is evaporated away to form a film. Before cast, preferably, the dope is so controlled as to have a solid concentration of from 18 to 35%. Preferably, the surface of the drum or the band is mirror-finished. Preferably, the dope is cast onto the drum or the band at a temperature not higher than 10 degrees Celsius.

In case where the dope (cellulose acylate solution) is cast onto a band, it is dried in the former half of the drying step prior to peeling the film, substantially with no air application thereto, for a period of from 10 seconds to 90 seconds, preferably from 15 seconds to 90 seconds. When the dope is cast onto a drum, preferably, it is dried in the former half of the drying step prior to peeling the film, substantially with no air application thereto, for a period of from 1 second to 10 seconds, preferably from 2 seconds to 5 seconds.

In the invention, “drying prior to peeling” means the drying time to be taken after dope application onto a band or a drum and before peeling of the formed film. “Former half” means the time to be taken for the former half of the entire step from dope application to film peeling. “Substantially with no air application” means that in a distance within 200 mm from the band surface or the drum surface, no air at a rate of 0.5 m/sec or more is detected (that is, the air flow rate is less than 0.5 m/sec). The former half of the drying before peeling is generally from 30 to 300 seconds or so in on-band casting. Of that period of time, the film is dried with no air application thereto, for a period of from 10 seconds to 90 seconds, preferably from 15 seconds to 90 seconds. In on-drum casting, in general, the former half of the drying before peeling is generally from 5 to 30 seconds or so. Of that period of time, the film is dried with no air application thereto, for a period of from 1 second to 10 seconds, preferably from 2 seconds to 5 seconds. The ambient temperature is preferably from 0 degree Celsius to 180 degrees Celsius, more preferably from 40 degrees Celsius to 150 degrees Celsius. The drying in no air flow may be attained in any stage of the former half of the drying stage, but preferably it is attained just after casting. When the drying time in no air flow is less than 10 seconds in on-band casting (less than 1 second in on-drum casting), the additive may be difficult to uniformly distribute inside the film; but when the time is longer than 90 seconds in on-band casting (longer than 10 seconds in on-drum casting), the film may be peeled away while it is insufficiently dried, and the film surface condition may be bad.

During the time except the drying time with no air application in the step of drying before peeling, the film may be dried with an inert gas flow given thereto. In this stage, the gas temperature is preferably from 0 degrees Celsius to 180 degrees Celsius, more preferably from 40 degrees Celsius to 150 degrees Celsius.

The drying stages of the solvent cast methods are described in U.S. Pat. Nos. 2,336,310, 2,367,603, 2,492,078, 2,492,977, 2,492,978, 2,607,704, 2,739,069, 2,739,070, British Pat. Nos. 640,731, 736,892, Japanese Patent Publication Nos. 45(1970)-4554, 49(1974)-5614, Japanese Patent Provisional Publication Nos. 60(1985)-176834, 60(1985)-203430 and 62(1987)-115035. The drying step on the band or drum may be carried out while air or inactive gas such as nitrogen is sent.

The formed film is peeled away from the drum or the band, and then it may be further dried with a high-temperature air flow having a successively changing temperature of from 100 to 160 degrees Celsius, thereby removing the residual solvent through evaporation. The process is described in JP-B 5-17844. According to the process, the time from the casting to the peeling may be shortened. In carrying out the process, the dope must be gelled at the surface temperature of he drum or the band on which it is cast.

Using the prepared cellulose acylate solution (dope), two or more layers may be cast for film formation. In this case, preferably, the cellulose acylate film is formed according to a solvent-casting method. A dope is cast on a drum or a band, and the solvent is evaporated away to form a film. Before cast, preferably, the dope is so controlled as to have a solid concentration of from 10 to 40%. Preferably, the surface of the drum or the band is mirror-finished.

In case where two or more layers are formed, plural cellulose acylate solutions (dopes) may be cast. Concretely, through plural casting mouths provided at intervals in the moving direction of the support, cellulose acylate solutions (dopes) are cast and laminated to form a film. For example, the method described in JP-A 61-158414, 1-122419 and 11-198285 can be employed. Cellulose acylate solutions (dopes) may be cast through two casting mouths to form a film. For example, the method described in JP-B 60-27562, JP-A 61-94724, 61-947245, 61-104813, 61-158413 and 6-134933 can be employed. Also employable is a casting method for a cellulose acylate film, comprising enveloping a flow of a high-viscosity cellulose acylate solution with a low-viscosity cellulose acylate solution and simultaneously casting the high/low-viscosity cellulose acylate solutions, as in JP-A 56-162617.

Another method of using two casting mouths is also employable, in which a dope is cast through the first casting mouth onto a support, then the resulting film is peeled away, and another dope is cast onto the film on the side thereof having faced the support, thereby producing a laminate film. For example, the method described in JP-B 44-20235 is referred to.

The same cellulose acylate solution or different cellulose acylate solution may be used. In order to make plural cellulose acylate layers have their respective functions, cellulose acylate solutions corresponding to the functions may be cast out through the respective casting mouths. Further, in the invention, the cellulose acylate solution may be cast along with any other solutions of other functional layers (e.g., adhesive layer, dye layer, antistatic layer, antihalation layer, UV absorbent layer, polarizing layer, etc.).

In a conventional single-layer dope casting method, a high-concentration and high-density cellulose acylate film must be cast in order to form a film having the necessary thickness. In such a case, the stability of the cellulose acylate solution is poor, and this is problematic in that solids may form to be fish eyes in the formed film, and the surface smoothness of the film is poor. To solve this problem, plural cellulose acylate solutions may be cast through plural casting mouths, whereby high-density solutions can be simultaneously cast on a support. In that manner, the surface smoothness of the formed film is bettered, and the film may have a good surface condition, and in addition, since such a thick cellulose acylate solution is used, the drying load may be reduced, and the film production speed can be promoted.

The preferred width of the cellulose acylate film of the invention is from 0.5 to 5 m, more preferably from 0.7 to 3 m. The preferred length of the film is from 300 to 30000 m, more preferably from 500 to 10000 m, even more preferably from 1000 to 7000 m.

### (Stretching)

The cellulose acylate film may be produced by stretching it to control retardation thereof. A method of positively stretching the film in the transverse direction (in the direction perpendicular to the machine direction in film formation) is described, for example, in JP-A 62-115035, 4-152125, 4-28411, 4-298310, and 11-48271. The film may be stretched at room temperature or under heat. The heating temperature is preferably within the range of the glass transition temperature of the film ±20 degrees Celsius. This is because, when the film is stretched at a temperature extremely lower than the glass transition temperature thereof, then the film may be often broken and could not express desired optical properties. On the other hand, when the film is stretched at a temperature extremely higher than the glass-transition temperature, then the molecular orientation by the stretching may be thermally relaxed by the stretching heat, before thermally fixed, and therefore the film could not express desired optical properties.

In a stretching zone (for example, in a tenter zone), in general, a zone may be provided in which the film is clipped and is expanded to the maximum expansion degree while transported therein, and then relaxed. This zone is necessary for reducing the axial shifting in the film. In the relaxation zone after the maximum processed for the maximum expansion in ordinary stretching, the time to be taken after passing through the tenter zone is shorter than 1 minute, and the film stretching may be monoaxial stretching only in the machine direction or the transverse direction, or may be successive biaxial stretching. Preferably, the film is stretched more in the transverse direction. Preferably, the film is stretched in a stretching ratio of from 1.4 times to 2 times in the transverse direction, or that is, in the direction perpendicular to the machine direction, more preferably the stretching ratio is from 1.4 times to 1.6 times, even more preferably from 1.4 times to 1.5 times.

The stretching may be attained during the film formation, or may be attained after the formed film is once wound up and it is unwound and then stretched. In the former case, the film may be stretched while it contains a residual solvent therein. Preferably, in stretching, the residual solvent amount (residual solvent amount/(residual solvent amount+solid content amount)) is from 0.05 to 50%. More preferably, the film is stretched by from 5 to 80%, while the residual solvent amount therein is from 0.05 to 5%.

The cellulose acylate film of the invention may be a biaxially-stretched film. Biaxial stretching includes simultaneous biaxial stretching and successive biaxial stretching. From the viewpoint of continuous production, a successive biaxial stretching method is preferred for the film of the invention, in which a dope is cast, and the formed film is peeled away from the band or the drum, then stretched in the transverse direction (or in the machine direction) and thereafter stretched in the machine direction (or in the transverse direction).

The process from the casting to the drying may be attained in an air atmosphere or in an inert gas atmosphere such as nitrogen gas.

As described in the above, the film stretched in the transverse direction, or that is, in the direction perpendicular to the machine direction is thereafter preferably processed in an additional step of blowing steam heated at 100 degrees Celsius or higher thereto. The steam blowing step is preferred, since the residual stress of the produced cellulose acylate film may be reduced after the step, and the dimensional change of the film is thereby reduced. The temperature of the steam may be 100 degrees Celsius or higher with no problem, but in consideration of the heat resistance of the film, the temperature of the steam may be not higher than 200 degrees Celsius.

The winding machine for use in producing the cellulose acylate film may be any ordinary one. For example, the film may be wound according to various winding methods of a constant tension method, a constant torque method, a tapered tension method, a programmed tension control method where the internal stress is kept constant, etc.

### (Surface Treatment of Cellulose Acylate Film)

Preferably, the cellulose acylate film is surface-treated. For the treatment, concretely mentioned are methods of corona discharge treatment, glow discharge treatment, flame treatment, acid treatment, alkali treatment, UV irradiation treatment. Also preferably, an undercoat layer is formed on the film, as in JP-A 7-333433.

From the viewpoint of maintaining the surface smoothness of the film, preferably, the cellulose acylate film is at a temperature not higher than Tg (glass transition temperature) thereof, concretely not higher than 150 degrees Celsius during the treatment.

In case where the film is used as a transparent protective film for polarizing plate, especially preferred for the film is acid treatment or alkali treatment, or that is, saponification of cellulose acylate of the film, from the viewpoint of enhancing the adhesiveness of the film to a polarizing element.

The surface energy is preferably at least 55 mN/m, more preferably from 60 mN/m to 75 mN/m.

As an example, alkali saponification of the film is concretely described below.

Preferably, the cellulose acylate film is alkali-saponified according to the cycle as follows: The film surface is dipped in an alkali solution, then neutralized with an acid solution, washed with water and dried.

The alkali solution includes potassium hydroxide solution, and sodium hydroxide solution. The hydroxide ion concentration in the solution is preferably within a range of from 0.1 to 3.0 mol/liter, more preferably within a range of from 0.5 to 2.0 mol/liter. The alkali solution temperature is preferably within a range of from room temperature to 90 degrees Celsius, more preferably within a range of from 40 to 70 degrees Celsius.

The surface energy of the solid may be determined according to a contact angle method, a wet heat method or an adsorption method as in “Basis and Application of Wetting Technology” (by Realize, issued on Dec. 10, 1989). For the cellulose acylate film of the invention, preferred is a contact angle method.

Concretely, two solutions of which the surface energy is known are separately dropped onto the cellulose acylate film; of the angle between the contact line drawn to the liquid drop and the film surface at the point at which the surface of the liquid drop crosses the film surface, the angle on the side of the liquid drop is defined as a contact angle, and the surface energy of the film can be computed through calculation.

The cellulose acylate film of the invention may have a single-layered structure or may comprise plural layers, but is preferably a single-layered film. “Single-layered” film as referred to herein means that it is not a lamination of plural film materials stuck together, but is in the form of one sheet of a cellulose acylate film. This includes a case of producing one sheet of a cellulose acylate film according to a successive casting method or a co-casting method with plural cellulose acylate solutions.

### 2. Applications of Cellulose Acylate Film:

The cellulose acylate film of the invention may be used in various applications. For example, it may be used for optical compensation films in liquid-crystal display devices, protective films for polarizing plates, etc.

### (Optical Compensation Film)

The cellulose acylate film of the invention may be used as an optical compensation film. “Optical compensation film” means an optical material having optical anisotropy generally for use in liquid-crystal display devices, etc., and this has the same meaning as that of an optical compensation sheet or the like. In a liquid-crystal display device, such an optical compensation film is used for the purpose of enhancing the contrast of the display panel, for widening the viewing angle and for reducing undesirable color shift. Plural cellulose acylate films of the invention may be laminated, or the cellulose acylate film of the invention may be laminated with any other films not falling within the scope of the invention, thereby suitably controlling Re and Rth of the resulting laminate to be an optical compensation film. The film lamination may be attained with a sticking paste or an adhesive.

### (Polarizing Plate)

The cellulose acylate film of the invention may be used as a protective film for polarizing plates, and the invention provides a polarizing plate comprising the film. One example of the polarizing plate of the invention comprises a polarizing film and two protective films (transparent films) for protecting both surfaces of the film, in which the cellulose acylate film of the invention is used as at least one of the polarizing plate-protective films. In an embodiment where the cellulose acylate film of the invention is used as a support and an optically-anisotropic layer of a liquid-crystal composition is formed on the surface of the support, and where the cellulose acylate film is used as a protective film for a polarizing plate, it is desirable that the back side (on which the optically-anisotropic layer is not formed) of the cellulose acylate film of the invention serving as a support is stuck to the surface of the polarizing film.

In case where the cellulose acylate film of the invention is used as a protective film for the polarizing plate, the cellulose acylate film of the invention is preferably hydrophilicated through the above-mentioned surface-treatment (e.g., as described in JP-A 6-94916 and 6-118232), and for example, the film is preferably processed for glow discharge treatment, corona discharge treatment, or alkali saponification. In particular, in case where the cellulose acylate to constitute the cellulose acylate film of the invention is cellulose acylate, the surface treatment of the film is most preferably alkali saponification.

As the polarizing film, for example, usable is a film produced by dipping a polyvinyl alcohol film in an iodine solution and stretching it. In case where the polarizing film produced by dipping a polyvinyl alcohol film in an iodine solution and stretching it is used, the surface-treated surface of the transparent cellulose acylate film of the invention may be directly stuck to both surfaces of the polarizing film with an adhesive. In that manner, it is desirable that the cellulose acylate film is directly stuck to the polarizing film. As the adhesive, usable is an aqueous solution of polyvinyl alcohol or polyvinyl acetal (e.g., polyvinyl butyral) or a latex of a vinylic polymer (e.g., polyvinyl acrylate). Especially preferred as the adhesive is an aqueous solution of a completely-saponified polyvinyl alcohol.

In general, in a liquid-crystal display device, a liquid-crystal cell is disposed between two polarizing plates. Therefore, the device has four polarizing plate-protective films. The cellulose acylate film of the invention may be used as any of those four polarizing plate-protective films, but the cellulose acylate film of the invention is especially useful as the protective film to be disposed between the polarizing film and the liquid-crystal layer (liquid-crystal cell) in the liquid-crystal display device. As the protective film to be disposed on the side of the polarizing film opposite to the side of the cellulose acylate film of the invention, a transparent hard coat layer, an antiglare layer, an antireflection layer or the like may be disposed, and in particular, the film of the invention is favorable as the polarizing plate-protective film to be disposed as the outermost surface layer on the display panel side of the liquid-crystal display devices.

### (Liquid-Crystal Display Device)

The cellulose acylate film of the invention and the optical compensation film and the polarizing plate comprising the film can be used in various display modes of liquid-crystal display devices. Above all, the cellulose acylate film of the invention and the optical compensation film and the polarizing plate comprising the film are favorably used in VA-mode liquid-crystal display devices. The liquid-crystal display devices may be any of transmission-mode, reflection-mode or semitransmission-mode devices.

### EXAMPLES

The characteristic features of the invention are described more concretely with reference to the following Examples and Comparative Examples. In these Examples, the material used, its amount and the ratio, the details of the treatment and the treatment process may be suitably modified or changed not overstepping the spirit and the scope of the invention. Accordingly, the invention should not be limitatively interpreted by the Examples mentioned below.

### Example 1

As in the Table given below, a cellulose acylate having a degree of substitution shown therein and an additive are used and formed into cellulose acylate films No. 1 to No. 9 according to the method mentioned below. Preparation of Fine Particle Dispersion:

The following ingredients were stirred and mixed to prepare a fine particle dispersion.

| | |
|---|---|
| Fine particles (R972V, by Nippon Aerosil) | 11 mas. pts. |
| Ethanol | 89 mas. pts. |

### Preparation of Fine Particle Additive Liquid:

A cellulose acylate was put into a dissolution tank with methylene chloride therein, in a ratio shown below, and completely dissolved under heat, then this was filtered through Azumi filter paper No. 244 (by Azumi Filter Paper). With fully stirring the filtered cellulose acylate solution, the fine particle dispersion prepared in the above was gradually added to it in a ratio shown in the following Table. Further, this was stirred with an attritor. This was filtered through Nippon Seisen's Finemet NF to give a fine particle additive liquid.

| | |
|---|---|
| Methylene chloride | 99 mas. pts. |
| Cellulose acylate (see the following Table) | 4 mas. pts. |
| Fine particle dispersion | 11 mas. pts. |

### Preparation of Main Dope Ingredient:

A main dope ingredient having the composition mentioned below was prepared. First, methylene chloride and ethanol were put into a pressure dissolution tank. Cellulose acylate was put into the pressure dissolution tank with the solvent therein, with stirring. This was heated and completely dissolved with stirring, and then a plasticizer shown in the following Table was added to and dissolved therein. This was filtered through filter paper No. 244 (by Azumi Filter Paper) to give a main dope ingredient.

### <Formulation of Main Dope Ingredient>

| | |
|---|---|
| Methylene chloride | 300 mas. pts. |
| Ethanol | 60 mas. pts. |
| Cellulose acylate (for the degree of substitution, | 73 mas. pts. |
| see the following Table) | |
| Additive (for the compound, see the following Table) | shown in the |
| | following Table. |

### Formation of Cellulose Acylate Film No. 1:

100 parts by mass of the main dope ingredient and 2 parts by mass of the fine particle additive liquid were well mixed in an in-line mixer (Toray's static in-line mixer, Hi-Mixer, SVII) to prepare a dope. Using a belt casting machine, this was uniformly cast onto a stainless band support having a width of 2 m. On the stainless band support, the film was dried to have a residual solvent content of 110%, and then peeled away from the stainless band support. While peeled, this was stretched under tension in the machine direction (MD) at a stretching ratio of 1.0 time. Then, with both sides thereof held by a tenter, the web was further stretched in the transverse direction (TD) at a stretching ratio of 1.3 times whereupon the residual solvent content at the start of the stretching was 20% by mass and the temperature of the web was 130 degrees Celsius. After thus stretched, this was kept as such for a few seconds with its width kept as such whereby the tension in the transverse direction was relaxed, and thereafter this was released from being held in the transverse direction. Further, this was conveyed through a third drying zone set at 125 degrees Celsius for 30 minutes and was thus dried to give a cellulose acylate film No. 1 having a thickness of 40 μm and a width of 1.5 m as knurled on both edges thereof to a width of 1 cm and a height of 8 μm.

### Formation of Cellulose Acylate Films Nos. 2 to 9:

Cellulose acylate films Nos. 2 to 9 were formed in the same manner as that for the cellulose acylate film No. 1, for which, however, the type of the cellulose acylate, the type and the amount of the additive, the stretching ratio and the thermal steam treatment were varied as in the Table shown below.

TABLE 2

| | | | | | | | Applying |
|---|---|---|---|---|---|---|---|
| | | | | | | | or |
| Cellulose | Cellulose acylate | | Additive | | | | not applying |
| acylate | Total degree | degree of | | Amount | Stretching | | thermal |
| film | of | substitution | | [% by | | temperature | steam |
| No. | substitution | with Pr *1 | Type *2 | mass] | ratio *3 | [° C.] | treatment *4 |
| 1 | 2.30 | 0.8 | — | — | 1.30 | 130 | No |
| 2 | 2.20 | 0.7 | — | — | 1.35 | 130 | No |
| 3 | 2.20 | 0.7 | — | — | 1.35 | 130 | No |
| 4 | 2.20 | 0.7 | (a)/(b) | 1.7/6.3 | 1.35 | 130 | No |
| 5 | 2.25 | 0.7 | (c) | 5 | 1.35 | 130 | No |
| 6 | 2.20 | 0.7 | (a)/(b) | 1.7/6.3 | 1.40 | 130 | No |
| 7 | 2.20 | 0.7 | (a)/(b) | 1.7/6.3 | 1.40 | 130 | Yes |
| 8 | 2.40 | 0.9 | (a)/(b) | 1.7/6.3 | 1.30 | 130 | No |
| 9 | 2.40 | 0.9 | (a)/(b) | 1.7/6.3 | 1.30 | 130 | No |

*1: Degree of substitution with propionyl group.
*2: (a) is a commercial product of homo-oligomer of methyl acrylate (mean molecular weight 1000); (b) is Compound 3 described in paragraph [0058] in WO2007/125764; and (c) is a polycondensation-ester plasticizer, Compound P-7.
*3: Stretching ratio in stretching in the transverse direction perpendicular to the machine direction.
*4: “yes” means that the film was treated with steam at 100 degrees Celsius or higher after the TD stretching treatment; and “No” means that the film was not treated so.

### Evaluation of Cellulose Acylate Films Nos. 1 to 9:

### (Re and Rth)

Thus formed Cellulose acylate films Nos. 1 to 9 were tested according to the method mentioned above to measure Re and Rth thereof.

### (|ΔRth|)

From the value of Rth Cellulose acylate films Nos. 1 to 9 measured in the manner as above, |ΔRth| thereof was obtained. Concretely, |ΔRth| was calculated as follows: First, each of the films was left at 25 degrees Celsius and 10% RH for 2 hours, and then tested in the same environment to determine its Rth value (this is “Rth_{10%}”). Next, the same film was subsequently left at 25 degrees Celsius and 80% RH for 2 hours, and then tested in the same environment to determine its Rth value (this is “Rth_{80%}”). From the found data, |ΔRth| was calculated according to the following formula:

|ΔRth|=|Rth_{10%}−Rth_{80%}|.

Further, the conditioned cellulose acylate film was again left in an environment at 25 degrees Celsius and 60% RH, and then tested in the same manner as above, from which the variation was confirmed as a reversible variation.

The other characteristic values of the films were measured according to the methods mentioned in the above.

The measured results are shown in the following Table.

TABLE 3

| | | | | | | | | modulus of | |
|---|---|---|---|---|---|---|---|---|---|
| Cellulose | | | | | | | | tensile | |
| acylate | | | | | | | | elasticity | |
| film | thickness | Re | Rth | | | haze | \|ΔRth\| | [MPa] | |
| No. | [μm] | [nm] | [nm] | Re/Re *1 | Rth/Rth *2 | [%] | [nm] | MD *3 | TD *4 |
| 1 | 40 | 54 | 125 | 0.91 | 0.92 | 0.31 | 13 | 3400 | 4850 |
| 2 | 36 | 60 | 115 | 0.90 | 0.91 | 0.27 | 12 | 3400 | 4950 |
| 3 | 30 | 50 | 100 | 0.90 | 0.91 | 0.25 | 10 | 3400 | 4950 |
| 4 | 30 | 53 | 105 | 0.90 | 0.91 | 0.23 | 7 | 3300 | 4850 |
| 5 | 30 | 57 | 105 | 0.92 | 0.92 | 0.25 | 7 | 3300 | 4850 |
| 6 | 30 | 60 | 118 | 0.90 | 0.91 | 0.27 | 8 | 3600 | 4900 |
| 7 | 30 | 59 | 120 | 0.90 | 0.91 | 0.27 | 8 | 3600 | 4900 |
| 8 | 50 | 54 | 125 | 0.93 | 0.94 | 0.36 | 15 | 3200 | 4800 |
| 9 | 35 | 38 | 95 | 0.93 | 0.94 | 0.20 | 8 | 3200 | 4800 |

*1: Re(450)/Re(630).
*2: Rth(450)/Rth(630).
*3: Modulus of tensile elongation in the machine direction.
*4: Modulus of tensile elongation in the transverse direction perpendicular to the machine direction.

As in the results given above, the cellulose acylate films Nos. 1 to 7 of the invention attained Re of at least 40 nm and Rth of at least 90 nm though they were thin films having a thickness of at most 40 μm. Accordingly, all the films of the invention have a small haze and have a sufficient retardation, and it is understood that they are useful as optical members for liquid-crystal display devices that are required to have high transparency. Above all, it is understood that |ΔRth| of the cellulose acylate films Nos. 4 to 7 containing a polycondensation-ester plasticizer, a saccharide plasticizer or an MA oligomer plasticizer as the additive is especially small.

The cellulose acylate films of Comparative Examples produced by the use of cellulose acylates of which the total degree of acyl substitution is outside the scope of the invention must be thickened in order that the films could have Re and Rth on the same level as that of the cellulose acylate films Nos. 1 to 7 of the invention, and as a result, it is understood that the haze of the comparative film increased and the transparency thereof was poor (Comparative Example 8). On the other hand, when the thickness of the comparative film is the same level as that of the cellulose acylate films Nos. 1 to 7 of the invention, then it is understood that Re of the comparative film could not be on the same level as that of the films of the invention.

### Example 2

Using the samples of Cellulose acylate films Nos. 1 to 9 formed in Example 1, polarizing plates P1 to P9 were formed.

### Alkali Saponification:

Each cellulose acylate film was saponified under the condition mentioned below, then washed with water, neutralized and washed with water in that order under the condition mentioned below, and then dried at 80 degrees Celsius.

Saponification Step: in 2 mol/L NaOH solution, 50 degrees Celsius, 90 seconds.

Washing Step: in water, 30 degrees Celsius, 45 seconds.

Neutralization Step: in 10 mas. % HCl solution, 30 degrees Celsius, 45 seconds.

Washing Step: in water, 30 degrees Celsius, 45 seconds.

### Formation of Polarizing Element:

A roll of a long polyvinyl alcohol film having a thickness of 120 μm was unrolled and dipped in 100 parts by weight of an aqueous solution containing 1 part by mass of iodine and 4 parts by mass of boric acid, and stretched at 50 degrees Celsius by 5 times in the machine direction to produce a polarizing film. To one side of the polarizing film, alkali-saponified Fujitac TD80 was stuck; and to the other side thereof, any of the above-mentioned, alkali-saponified cellulose acylate films Nos. 1 to 9 was stuck, each with an aqueous 5% solution of completely-saponified polyvinyl alcohol serving as an adhesive. After dried, polarizing plates P1 to P9 were produced.

### Production of Liquid-Crystal Display Device:

The two polarizing plates originally stuck to a VA-mode liquid-crystal display device, Fujitsu's 15-type display VL-150SD were peeled away, and any of the above-produced polarizing plates, P1 to P9, was stuck to the glass surface of the liquid-crystal cell (VA-mode) to thereby reconstruct Liquid-crystal display devices Nos. 1 to 9.

In these, the polarizing plates were so disposed that their absorption axis runs in the same direction as that of the original polarizing plates.

### Evaluation of Liquid-Crystal Display Device:

The produced liquid-crystal display devices were tested in the manner mentioned below.

In an environment at 25 degrees Celsius and 60% RH, the viewing angle of the liquid-crystal display device was measured, using ELDIM's EZ-Contrast 160D. Next, in an environment at 25 degrees Celsius and 10% RH and in an environment at 25 degrees Celsius and 80% RH, the viewing angle of the liquid-crystal display device was measured. According to the criteria described below, the humidity stability of the viewing angle was evaluated. Last, the viewing angle of the device was again measured in an environment at 25 degrees Celsius and 60% RH, from which the variation in the above measurement was confirmed as a reversible variation. In every measurement, the liquid-crystal display devices were left in the environment for 2 hours, and then tested in the same environment.

Liquid-crystal display devices Nos. 1 to 7 of the invention had a thin panel and exhibited good display performance. In particular, Liquid-crystal display devices Nos. 4 to 7 were good, as their display performance changed little depending on the ambient humidity change.

On the other hand, the panel of Liquid-crystal display device No. 8 was thicker than that of Liquid-crystal display devices Nos. 1 to 7, and the front contrast (in the normal line direction relative to the panel surface) thereof was low. The display performance of Liquid-crystal display device No. 9 was inferior to that of Liquid-crystal display devices Nos. 1 to 7.

What is claimed is:

1. A cellulose acylate film whose thickness is from 10 μm to 40 μm, retardation in plane at a wavelength 590 nm, Re(590), satisfies 40 nm≦Re(590)≦70 nm, and retardation along the thickness direction at a wavelength 590 nm, Rth(590), satisfies 90 nm≦Rth(590)≦150 nm; and
which comprises at least cellulose acetate propionate, cellulose acetate butyrate or cellulose acetate propionate butyrate, having a total degree of acyl substitution of from 2 to 2.35 and a degree of propionyl and/or butyryl substitution of from 0.6 to 1.1.

2. The cellulose acylate film according to claim 1, which satisfies 57 nm≦Re(590)≦70 nm and 90 nm≦Rth(590)≦120 nm.

3. The cellulose acylate film according to claim 1, which has a haze, Hz, of from 0% to 0.3%.

4. The cellulose acylate film according to claim 1, which satisfies the following two relations:
0.7<Re(450)/Re(630)<0.92,
0.7<Rth(450)/Rth(630)<0.95.

5. The cellulose acylate film according to claim 1, which comprises at least one compound selected from a group consisting of monomers or 2- to 10-multimers of saccharides and their derivatives in an amount of from 0.1% by mass to 20% by mass.

6. The cellulose acylate film according to claim 1, which comprises at least one polycondensation-ester derivative of a dicarboxylic acid component comprising at least one aromatic dicarboxylic acid and at least one aliphatic dicarboxylic acid, and an ethylene glycol and/or an aliphatic diol having from more than 2.0 to 3.0 carbon atoms on average, and wherein both terminal OH groups of the polycondensation-ester form an ester with a monocarboxylic acid.

7. The cellulose acylate film according to claim 5, which satisfies the following relation:

|ΔRth|≦8 nm,
wherein |ΔRth| is an absolute value of the difference between Rth(590) of the film measured at 25 degrees Celsius and 10% RH and Rth(590) thereof measured at 25 degrees Celsius and 80% RH.

8. The cellulose acylate film according to claim 1, which is formed according to a solution casting method.

9. The cellulose acylate film according to claim 8, which is a film stretched at a stretching ratio of from 1.4 times to 2 times in the direction perpendicular to the machine direction in film formation.

10. The cellulose acylate film according to claim 9, which is a film produced through a step of blowing steam heated at 100 degrees Celsius or higher to the film stretched in the direction perpendicular to the machine direction in film formation.

11. The cellulose acylate film according to claim 9, of which the modulus of tensile elasticity in an environment at 25 degrees Celsius and 60% RH in both the long side direction and the short side direction thereof is from 3500 MPa to 6000 MPa.

12. An optical compensation film formed of a cellulose acylate film of claim 1, or comprising a cellulose acylate film of claim 1.

13. A polarizing plate comprising at least a polarizing element and a cellulose acylate film of claim 1.

14. A liquid-crystal display device comprising at least a cellulose acylate film of claim 1.
